(19) United States
(12) Patent Application Publication
(10) Pub. No.: US 2022/0414751 A1
(43) Pub. Date: Dec. 29, 2022

(54) E-COMMERCE WEBSITE WITH APPROVAL AND STATUS UPDATES FROM A CUSTOMER SYSTEM

(71) Applicant: Amazon Technologies, Inc., Seattle, WA (US)

(72) Inventors: Mathieu Dumais Savard, Montreal (CA); Ankur Anand, Hyderabad (IN); Vikash Kumar Jain, Hyderabad (IN); Priyanka Pitchuka, Secunderabad (IN); Satya S. Mishra, Redmond, WA (US); Neha Goswami, Bellevue, WA (US)

(73) Assignee: Amazon Technologies, Inc., Seattle, WA (US)

(21) Appl. No.: 17/362,811

(22) Filed: Jun. 29, 2021

(51) Int. Cl. G06Q 30/06

(52) U.S. Cl. CPC G06Q 30/0637; G06Q 30/0641

(57) ABSTRACT

A system is disclosed allowing a buyer to directly build a shopping cart(s) on a supplier's portal (such as website, applications) without initiating any shopping request from company's network or system (such as eProcurement system). A standard cXML document can be used to transmit a Punchout Order Message (POOM) address to a customer system where the POOM can be retrieved. Additionally, a buyer identifier (e.g., an email address) can be included in the cXML document so that the customer system can verify the buyer making purchases. An address is returned to the supplier's portal, which can be used by the buyer to complete the purchase. In one example, the address directs the buyer to log into the customer system to verify the purchase.

### BACKGROUND

In a business-to-business (B2B) e-commerce context, business customers often use online supplier websites to purchase products directly from other businesses or the B2B goods suppliers. For example, businesses can purchase office supplies, manufacturing parts, janitorial supplies, and other products directly from other businesses. B2B customers often use their home grown or 3P procurement systems (also referred to as eProcurement systems, spend management systems, punchout systems, supplier management portals, travel & expense management systems, etc.) to manage such procurement needs. Such systems are integrated with the supplier's website to allow their employees or authorized buyers of the procurement systems to make purchases from the supplier's website through their procurement systems. The use of the procurement systems allows for greater visibility and control into the organization's purchases and for compliance with internal policies of the businesses.

For example, buyers can log into the 3P procurement system, then via links in the 3P system (e.g., via a click button), login to the supplier's website (e.g., supplier system, which is an e-commerce provider). Once they are on the supplier website, the buyer then searches for the items to buy and builds a shopping cart of these items. This method of accessing a supplier's web-catalog or e-commerce website from within the B2B customer's procurement system is often referred to as “Punchout.” Once a buyer “punches out” and builds the cart on the supplier's website, the buyer then transfers the cart back to their procurement system. Thus, the buyer's employees can access and shop in an e-commerce website without leaving the buyer's platform. After the shopping cart is received back in the buyer's procurement system, the buyer performs administrative actions within the procurement system to send the cart for approval to their supervisor or accounting department, who approves the cart. After approval, the procurement system sends a purchase order to the supplier system.

### BRIEF DESCRIPTION OF THE DRAWINGS

FIG. 1 is a system diagram, according to a first embodiment, for ordering products directly through a supplier website.

FIG. 2 is a flow diagram for using the system of FIG. 1

FIG. 3 is a flow diagram, according to another embodiment, for ordering products directly through a supplier website.

FIG. 4 is a flow diagram, according to yet another embodiment, for ordering products through a supplier website.

FIG. 5 is a flow diagram, according to another embodiment, for ordering products through a supplier website.

FIG. 6 depicts a generalized example of a suitable computing environment in which the described innovations may be implemented.

### DETAILED DESCRIPTION

A system is disclosed allowing a buyer to directly build a shopping cart(s) on a supplier's portal (such as a website, applications, etc.) without initiating any shopping request from company's network or system (such as eProcurement system). A standard structured computer file formatted document (e.g., cXML, OCI, EDI, etc.) can be used to transmit a cart URL (e.g., a Punchout Order Message (POOM) address) to a customer system where the cart can be retrieved. Additionally, a buyer identifier (e.g., an email address) can be included in the document so that the customer system can verify the buyer making purchases. An address (URL) is returned to the supplier's portal, which can be used by the buyer to complete the purchase. In one example, the address directs the buyer to log into the customer system to verify the purchase.

A system is proposed that enables a business buyer (typically an employee of a customer or business entity) to add items to a list of products (e.g. build a shopping cart) without initiating a shopping session from their company's eProcurement system. Prior systems required buyers to login to their own customer system to buy products from a supplier (i.e., an E-commerce website), which can be limiting if the buyer is on a mobile device or away from a typical office environment or network. The disclosed system allows the buyer to log directly onto the supplier website and allows the customer system to verify the buyer and to retrieve the items in the shopping cart. Furthermore, status updates are passed from the customer system to the supplier. The customer system can also supply an address, such as a URL, to the supplier for the supplier's portal to display to the buyer. The address can be used by the buyer to complete next steps required by the customer system. For example, the buyer can click on a URL and be directed to the customer system to log into the customer system. Communications between the supplier and the customer system can be completed using a structured computer file format, such as a cXML document. However, other formats can be used, such as (e.g., XML, JSON, EDI, CSV or any API-defined formats).

Thus, the buyer can search, browse, compare, and buy products from an e-commerce website associated with the supplier without using any controlled environment of buyer's eProcurement system. The system integrates an eProcurement platform and the e-commerce website, which allows shopping and ordering data to flow seamlessly therebetween. A business buyer with a customer eProcurement system provides the supplier certain system integration details, such as a URL, where a setup request is to be sent and how employees of the business buyer are to be identified (e.g. e-mail, cookie, authentication token, etc.). Further details can include how the eProcurement system identifies itself to the supplier system (e.g. authentication token, SSO, etc.) Once a cart is created by a buyer, the buyer is identified as associated with the customer and the supplier transmits a POOM URL and buyer identifier to the customer system for review and/or approval. The customer system sends a response to the setup request that includes the URL directing the buyer how to proceed next. Once the buyer clicks or follows the URL, a status message can be transmitted by the customer system to the supplier indicating that the buyer took the action requested.

Thus, the buyer need not be in the customer eProcurement application network to create a shopping session on the supplier network. Additionally, the buyer can utilize a Mobile Shopping Application for enterprise buying. Finally, the buyer can obtain an end-to-end e-commerce-website experience for enterprise buying.

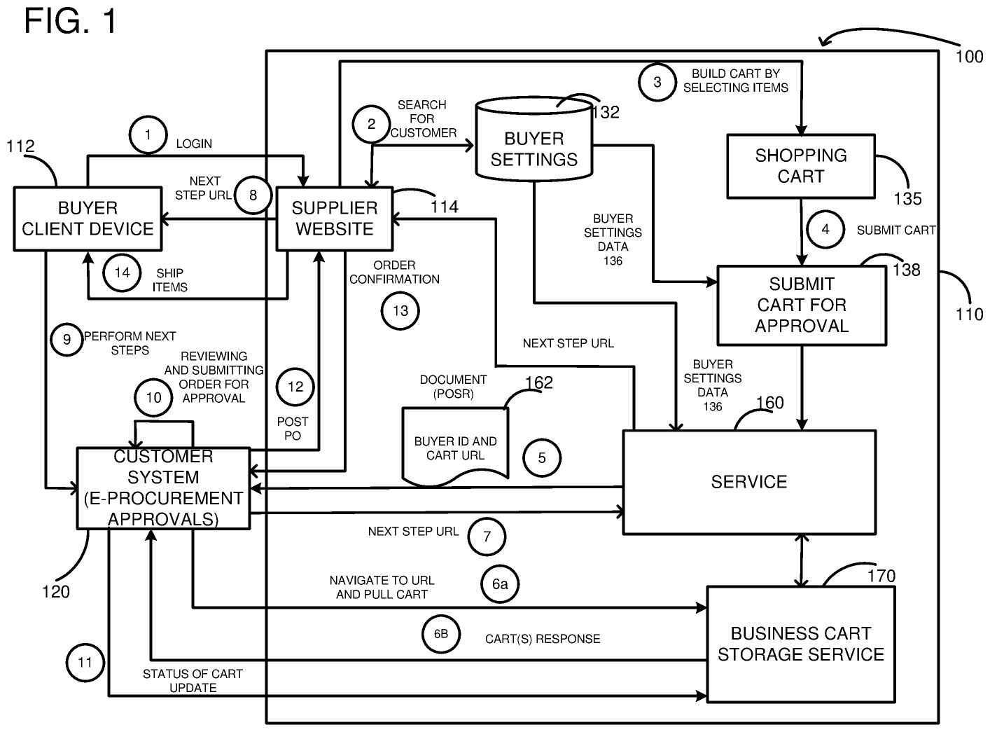

FIG. 1 shows a first embodiment of a system 100 for ordering products directly through a supplier network 110. A buyer operating a client device 112 accesses a supplier website 114 of the supplier system 110. The supplier website 114 (which is an e-commerce provider) allows consumers and businesses to purchase products using e-commerce. The supplier website 114 is typically executing on a plurality of server computers within the supplier network 110. The buyer is an employee of a customer associated with a customer system 120 that requires approvals of purchases made by the buyer on behalf of the business. The customer system is any business that desires purchasing goods from the supplier system 110 in a B2B e-commerce context. More generally, the customer system can be an eProcurement system or any system that performs e-commerce activity. The client device 112 can be any client device, such as a mobile phone, tablet, laptop computer, etc. that can send and receive signals to the Internet. Notably, the buyer operating the client device 112 does not login to the customer system 120 and access the supplier system 110 through the customer system. Instead, the buyer operating the client device 112 logs directly into the supplier website 114. The supplier system 110 further includes a database 132 for storing buyer settings. For example, an administrator of the customer system 120 configures a buyer business account for enabling its employees to purchase directly (i.e., without logging into the customer system) from the supplier system 110. The administrator further provides an identification strategy allowing the supplier system 110 to identify the buyer 112 as associated with the customer system 120. Example, identification strategies include using a buyer-specific unique identifier (Email ID, Mobile Number, third-party common keys, cookie, token, etc.), SSO details or Third-Party authentication and authorization. Other configurations can include providing a URL by the customer system 120 where to push a POOM URL and the buyer-specific unique identifier. To configure the buyer settings 132, the customer system 120 can submit the settings through an API to the supplier website 114. The supplier website 114 can then populate the buyer settings in the database 132.

To further understand interactions between the buyer client device 112, the customer system 120 and the supplier system 110, circled numbers are indicated relating to example steps that can occur. At 1, a buyer using the buyer client device 112 logs directly into a supplier website 114 to purchase goods, just the same as a general consumer (unaffiliated with the customer system) logs into the supplier website 114. The buyer login is typically using credentials associated with a business account. At 2, the supplier website 114 searches the buyer login details in the database 132, such as by searching using a parameter of the credentials as a key (e.g., an email address). If a match is found, then the supplier website 114 identifies the buyer as associated with the customer and its customer system. Other business account details and setup properties are also retrieved from the database 132. At 3, the buyer creates a shopping cart 135 on the supplier website 114, such as by placing one or more products in a shopping cart for purchase. The shopping cart is software that includes identifiers associated with products to purchase. At 4, the buyer submits the shopping cart 135 for approval 138 and the supplier system 110 checks the previously retrieved properties (shown as buyer settings data 136). If the buyer is associated with the customer system, a service 160 uses the buyer settings data 136 from the database 132 to generate a document 162 (a POSR) that includes a cart URL (e.g., a POOM) and the buyer identifier (e.g., a buyer email address). The service 160 is executing on one or more server computers within the supplier system 110. At 5, in a setup request, the document 162 is transmitted to the customer system to an address as specified by the buyer settings data 136. In one example, the document uses a structured file format (e.g., standard cXML), such as using the “Extrinsic” tag to embed the buyer identifier and the POOM URL.

The service 160 posts the products of the shopping cart to the URL. The service 160 uses the shopping cart data from current session to create the POOM content, and then adds the information specified by the identification strategy from the buyer settings data 136 as meta data in the POOM. The POOM includes the shopping cart items (including a unique product identifier for each product) that the buyer checked out from the e-commerce site 114. The POOM can be stored in a business cart storage service 170. At 6A, the customer system 120 navigates to the URL supplied in the cXML document 162 and pulls the product data associated with the shopping cart (see 6B). The URL supplied to the customer system 120 can be directed to the separate business cart storage service 170. Thus, in one embodiment, a list of product identifiers associated with the shopping cart can be transmitted to the customer system. In the case of SSO, the service 170 can establish an SSO connection with the customer system 120 and supply information associated with the shopping cart to the customer system.

In some embodiments, the customer system 120 calls the supplier website 114 using an API to retrieve an authentication token. The customer system then uses APIs and the authentication token along with cart filters (identifiers (e.g., a cookie, email address, or token), user name, etc.) to obtain the cart data from a business cart storage service 170 executing on one or more server computers in the supplier system 110. The service 170 returns the desired cart or carts at 6B.

Before, during or after 6A and 6B, at 7, the customer system transmits a setup response, which includes a next-step URL. In one embodiment, the next-step URL is an address that the buyer should click on or follow to complete the purchase. Generally, the URL directs the buyer to the customer system where additional steps are carried out to as a pre-requisite to a purchase order being generated. An additional message can be displayed to the buyer directing the buyer how to proceed. The service 160 receives the next-step URL and submits it to the supplier website 114 for display to the buyer at 8. The next-step URL can be embedded in a structured computer file format, such as a standard cXML document. Once the next-step URL is displayed, the buyer can click on the displayed link, as shown at 9, and is transferred to the customer system 120 to login or perform any final steps desired by the customer system. Once the buyer has completed the requested steps, at 10, the customer system reviews and submits the order for approval. The approval process can take any desired period of time in accordance with the internal process of the customer system. To ensure that the business cart storage service 170 does not time out, at 11, the customer system 120 can provide a status update, such as that the cart has moved for approval and the buyer has completed all necessary steps needed for approval. If the status of cart update is not received, the supplier system 110 can transmit a message to the buyer that a step has not yet been completed and re-supply the URL. On the other hand, such a message is not transmitted after the status of cart update is received.

Once the cart is received by the customer system 120 and the buyer performed the next steps at 9, an approval procedure is implemented, which can be automated, manual, or a combination of the two. Based upon the internal business rules of the customer system 120, the cart is approved, meaning one or more products in the cart are approved for purchase from the supplier system 110. The approval of the cart can be a partial approval (some of the products), a full approval (all products approved), or a rejection of the cart. Approval of the cart includes reviewing the products in the cart and determining whether the items comply with or violate internal business policies of the customer system 120. For example, a business might allow the purchase of office supplies, but not allow alcohol. At 12, a purchase order (PO) is transmitted or otherwise posted to the supplier website 114. For approved items in the cart, the customer system generates the PO according to regular business practices between the supplier website and the customer system. At 13, the order is confirmed indicating that it has been accepted for shipment. At 14, the items are shipped either to the buyer 112 or to the customer system 120.

Some of the advantages of the system 100 include the ability for a buyer to log directly into the supplier website 114 and purchase on behalf of the customer system without first starting in the customer system website. Additionally, status updates from the customer system are provided to the supplier website 114. Still further, a link from the customer system is displayed on the supplier website 114 and the buyer needs to click on the link and be directed to the customer system to complete the purchase on the supplier website.

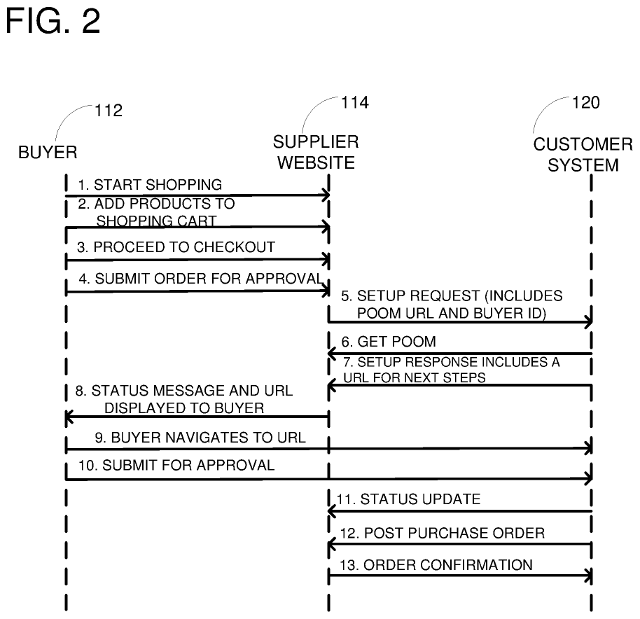

FIG. 2 shows a flow of interactions between the buyer 112, the supplier website 114 and the customer system 120 using the system of FIG. 1. At 1, the buyer (using the client device) begins a shopping session by logging into the supplier website 114. Typically, login credentials are required, such as a username and password. While browsing for products on the supplier website, at 2, the buyer adds products to a shopping cart. At 3, the buyer proceeds to a checkout window. At 4, the buyer submits the order for approval. In this case, approval of the order comes from the customer system affiliated with the buyer. At 5, a setup request is transmitted from the supplier website 114 to the customer system 120. The setup request can be transmitted to a URL defined by the customer system 120 and stored in the buyer settings 132 (FIG. 1). The setup request includes a POOM URL (i.e., an address where to obtain the POOM), and a buyer identifier, such as an email address. The request uses a structured computer file format, such as a cXML document with the POOM URL and buyer identifier embedded therein. In one example, the Extrinsic tag in cXML can be used, as follows:

<Extrinsic name=“UserEmail”>buyername@customer.com</Extrinsic>
<Extrinsic name=“PoomUrl”>https://www.supplier.com/eProcurement/poom?pid=c55555c0-
66c9-777b-8888-d999a555c55e</Extrinsic>

The cXML request using Extrinsic[name=“UserEmail”] allows customer systems, such as eProcurement systems, to identify the buyer. The cXML request using Extrinsic[name=“PoomUrl”] tells the eProcurement system where to get the PunchOutOrderMessage for this order. The setup request can use an SSL certificate issued by a certificate authority for additional security.

At 6, the customer system 120 retrieves the POOM using the POOM URL. At 7, the customer system 120 sends a response to the setup request (step 5) and the response includes a URL to be displayed to the buyer so that the buyer can use the URL to follow next steps as controlled by the customer system. Thus, the customer system is controlling a part of the purchasing flow on the supplier website 114. An example setup response uses a structured computer file format, such as standard cXML and is as follows:

```
        <cXML payloadID=“1234567890.123456@host.com” timestamp=“2021-03-
10T15:56:21.586Z”>
  <Response>
    <Status code=“111” text=“success” />
    <PunchOutSetupResponse>
      <StartPage>
        <URL>https://www.myeprocurement.com/punchin/address
&requiresAuthByCredentials=1&requiresAuthBySSO=1&buyerExists=1&mobileSupported=1&
internetSupported=1</URL>
      </StartPage>
    </PunchOutSetupResponse>
  </Response>
</cXML>
```

At 8, the text message is displayed to the buyer on the supplier website. Thus, in the above example, the buyer sees a message “success” together with the link included in the response. At 9, the buyer navigates to the URL supplied by the customer system and the buyer follows a flow controlled by the customer system to complete the purchase process. At 10, order processing proceeds by the customer system according to internal policies of the customer. For example, the buyer can be directed to answer various questions about the order so that the order is submitted for approval. At 11, a status update is provided to the supplier website. At 12, the customer submits a purchase order and the supplier website confirms the order at 13 to complete the purchasing process.

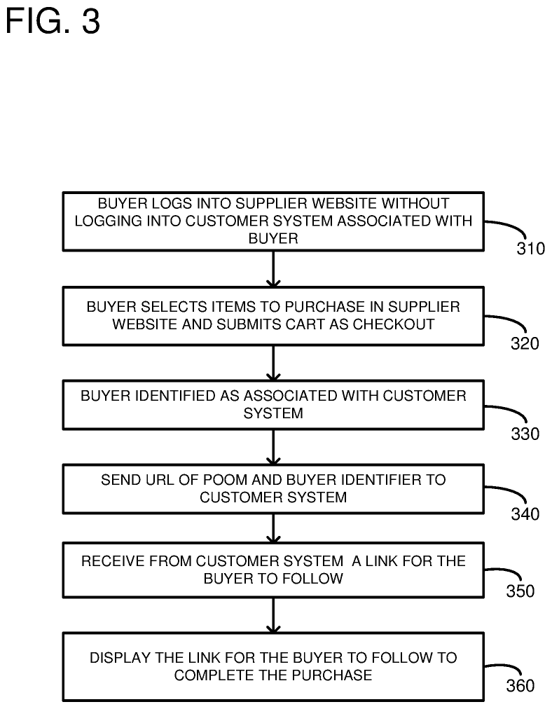

FIG. 3 is a flowchart according to one embodiment for purchasing products on a supplier website. In process block 310, a buyer logs into a supplier website without logging into a customer system associated with the buyer. For example, in FIG. 1, the buyer client device 112 directly logs into the supplier website 114 instead of logging into the customer system 120 and accessing the supplier website 114 via the customer system. In process block 320, the buyer selects items to purchase in the supplier website (which are placed in a shopping cart) and submits the cart at checkout. Thus, in FIG. 1, the buyer builds the shopping cart 135 by selecting items to purchase and adding them to the shopping cart. The shopping cart 135 thereby includes a list of products, each of which is associated with a unique identifier. The buyer can then select an option to checkout. At process block 330, the buyer is identified as associated with the customer system such that an approval process incorporating the customer is needed. For example, in FIG. 1, the buyer's login credentials are checked in the database 132 and it is determined that the buyer is associated with a customer system, which makes the purchase flow different from other buyers, acting as individuals. In process block 340, a URL of a POOM and a buyer identifier are transmitted to the customer system. For example, in FIG. 1, at 5, the buyer email and an address of where the POOM is located are embedded in a cXML document. The buyer email can be changed to other identifiers. In process block 350, a link is received from the customer system for the buyer to select to complete the purchase. For example, in FIG. 1, at 7, the URL is provided to the service 160. At process block 360, a URL is displayed to the buyer to follow. For example, in FIG. 1, on the supplier website 114, the next-step URL is presented to the buyer at 8. The supplier website can also display a desired message in association with the URL explaining to the buyer what to expect next (e.g., log into the customer system and answer questions about the purchase.)

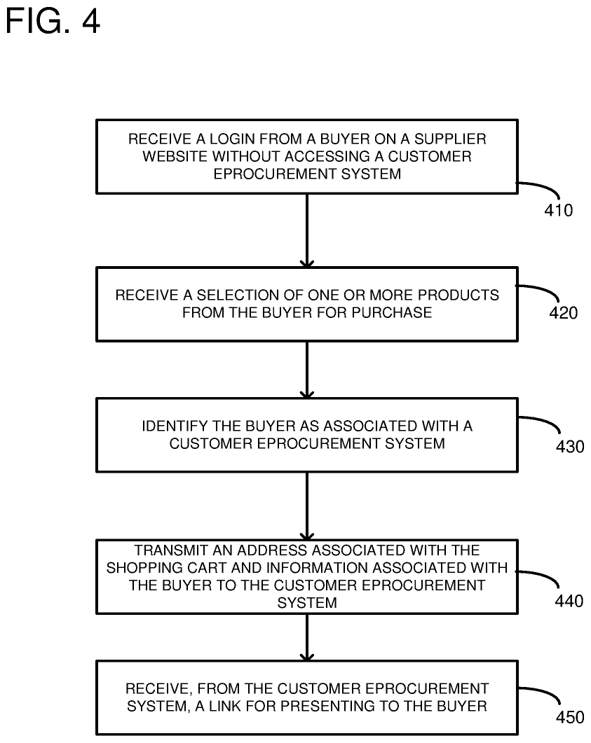

FIG. 4 is another embodiment for purchasing products from a supplier website. In process block 410, a login is received from a buyer on a supplier website without accessing the customer eProcurement system. For example, in FIG. 1, the buyer client device 112 directly logs into the supplier website 114 instead of logging into the customer system 120. In process block 420, a selection is received of one or more products to be placed in a shopping cart for purchase. In process block 430, the buyer is identified as associated with the customer system. For example, the buyer's login credentials are used to search the buyer settings database 132. If a match is found, then the buyer is automatically associated with the customer system 120, which needs to approve any purchases by the buyer. In process block 440, an address is transmitted to the customer system, wherein the address is associated with the shopping cart. For example, the address can be an address to retrieve the POOM. Additionally, information associated with the buyer can be transmitted to the customer system. The information associated with the buyer can be an identifier of the buyer, such as an email address. For example, in FIG. 1, the service 160 transmits a document 162, such as a cXML document, including the buyer ID and the cart URL. In process block 450, a link is received from the customer eProcurement system for presenting to the buyer. For example, in FIG. 1, the link can be supplied from the customer system 120 to the service 160, which directs the link to be displayed on the supplier website 114 for the client device 112.

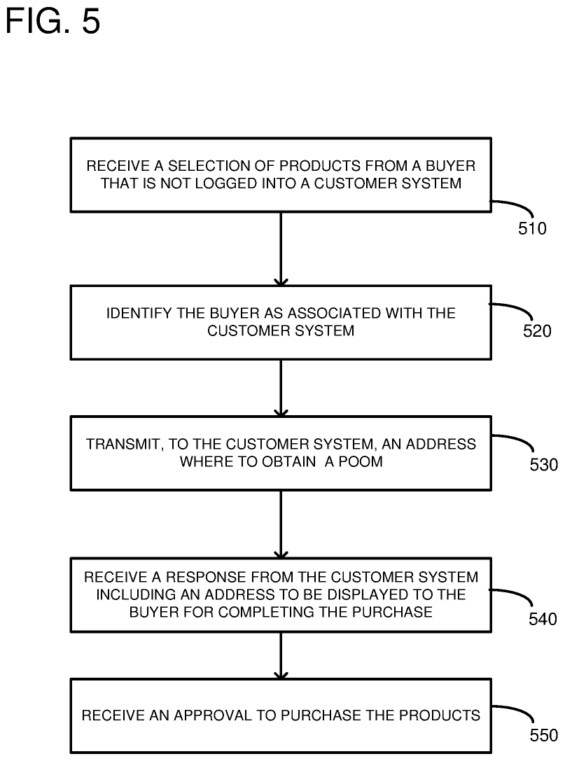

FIG. 5 is a flowchart according to yet another embodiment. In process block 510, a selection of products is received from a buyer that is not logged into a customer system. In process block 520, the buyer is identified as associated with the customer system, such as by using the buyer's login credentials. In process block 530, a supplier network can transmit, to the customer system, an address where to obtain a POOM associated with the selection of products. For example, in FIG. 1, the POOM URL is shown as included in the cXML document 162. The URL points to an address associated with the business cart storage service 170. In process block 540, a response is received from the customer system including an address to be displayed to the buyer for completing the purchase. For example, in FIG. 2, at 7, the next-steps URL is transmitted to the supplier website for display to the buyer. Additional instructions can also be displayed to the buyer. The URL can be customized and unique to the buyer and the cart and provides an additional layer of security that the parties are not fraudulent. In addition, the customer system and the supplier network can mutually authenticate. In process block 550, an approval is received to purchase the products. For example, in FIG. 2, at 12, a PO is posted to the supplier website 114 to complete the purchases of the selected products.

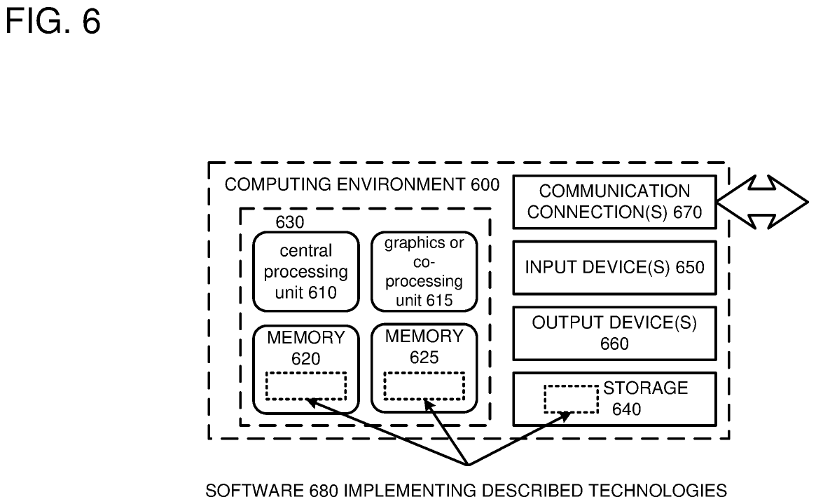

FIG. 6 depicts a generalized example of a suitable computing environment 600 in which the described innovations may be implemented. The computing environment 600 is not intended to suggest any limitation as to scope of use or functionality, as the innovations may be implemented in diverse general-purpose or special-purpose computing systems. For example, the computing environment 600 can be any of a variety of computing devices (e.g., desktop computer, laptop computer, server computer, tablet computer, etc.). FIG. 6 can be used as any of the e-commerce website, the customer procurement system, or the buyer client device.

With reference to FIG. 6, the computing environment 600 includes one or more processing units 610, 615 and memory 620, 625. In FIG. 6, this basic configuration 630 is included within a dashed line. The processing units 610, 615 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s). The memory 620, 625 stores software 680 implementing one or more innovations described herein, in the form of computer-executable instructions suitable for execution by the processing unit(s).

A computing system may have additional features. For example, the computing environment 600 includes storage 640, one or more input devices 650, one or more output devices 660, and one or more communication connections 670. An interconnection mechanism (not shown) such as a bus, controller, or network interconnects the components of the computing environment 600. Typically, operating system software (not shown) provides an operating environment for other software executing in the computing environment 600, and coordinates activities of the components of the computing environment 600.

The tangible storage 640 may be removable or non-removable, and includes magnetic disks, magnetic tapes or cassettes, CD-ROMs, DVDs, or any other medium which can be used to store information in a non-transitory way and which can be accessed within the computing environment 600. The storage 640 stores instructions for the software 680 implementing one or more innovations described herein.

The input device(s) 650 may be a touch input device such as a keyboard, mouse, pen, or trackball, a voice input device, a scanning device, or another device that provides input to the computing environment 600. The output device(s) 660 may be a display, printer, speaker, CD-writer, or another device that provides output from the computing environment 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only examples of the invention and should not be taken as limiting the scope of the invention. We therefore claim as our invention all that comes within the scope of these claims.

What is claimed is:

1. A method of purchasing products on a supplier website for a business, the method comprising:
receiving a login from a buyer on the supplier website without accessing a customer eProcurement system;
receiving a selection of one or more products from the buyer for purchase and placing the one or more products in a shopping cart;
identifying the buyer as associated with the customer eProcurement system requiring review of a purchase;
transmitting an address associated with the shopping cart from the supplier website to the customer eProcurement system and transmitting information associated with the buyer from the supplier website to the customer eProcurement system; and
receiving in the supplier website, from the customer eProcurement system, a link for presenting to the buyer to follow for further steps to complete the purchase at the customer eProcurement system.

2. The method of claim 1, further including receiving, from the customer eProcurement system, a status update indicating that the buyer has followed the link and submitted their order for approval.

3. The method of claim 1, further including receiving, from customer eProcurement system, a request at the address for identifying information for the one or more products in the shopping cart and transmitting the identifying information to the customer eProcurement system.

4. The method of claim 1, wherein the information associated with the buyer includes an email address of the buyer.

5. The method of claim 1, wherein the transmitting of the address and the information associated with the buyer is within a commerce extensible markup language (cXML) document.

6. A method, comprising:
receiving a selection of one or more products from a buyer logged into a supplier website, wherein the buyer is not logged into a customer system for which the one or more products are being purchased;
identifying the buyer as associated with a customer system;
transmitting to the customer system an address where to obtain a Punchout Order Message (POOM) associated with the selected products at the supplier website;
receiving, from the customer system, a response including an address associated with the customer system to be displayed to the buyer by the supplier website for completing a purchase of the one or more products, wherein the address is customized for the purchase of the selected products; and
receiving from the customer system an approval to purchase the one or more products.

7. The method of claim 6, further including receiving, from the customer system, a status update indicating that the buyer has followed the address and submitted their order for approval.

8. The method of claim 6, wherein the address transmitted to the customer system is in a commerce extensible markup language (cXML) document.

9. The method of claim 8, wherein the cXML document further includes an email address of the buyer to identify the buyer.

10. The method of claim 6, wherein the customer system is an eProcurement system or a system that performs e-commerce activity.

11. The method of claim 6, further including receiving a request by the customer system to download the POOM.

12. The method of claim 6, further including receiving, from the customer system, a purchase order for products in the POOM.

13. The method of claim 6, further including receiving a buyer identifier from a database and transmitting the buyer identifier to the customer system.

14. The method of claim 6, further including displaying instructions to the buyer in association with the address.

15. The method of claim 6, wherein the address associated with the customer system directs the buyer to log into the customer system to complete the purchase.

16. One or more non-transitory computer-readable storage media storing computer-executable instructions for causing a computing system to perform a method, the method comprising:
receiving a login request in a supplier website from a buyer, without the buyer being logged into a customer system;
identifying the buyer as being associated with the customer system by comparing a buyer identifier to stored identifiers in a database;
receiving a request to purchase products on the supplier website from the buyer;
transmitting, to the customer system, an address where to obtain a Punchout Order Message (POOM) associated with the supplier website together with the buyer identifier;
receiving, from the customer system, an address that the buyer should select to complete the purchase;
transmitting information associated with the products to the customer system; and
receiving a purchase order from the customer system for the products.

17. The one or more non-transitory computer-readable storage media of claim 16, wherein the method further comprises:
displaying, to the buyer, the address received from the customer system.

18. The one or more non-transitory computer-readable storage media of claim 16, wherein the address where to obtain the POOM is embedded within a commerce extensible markup language (cXML) document.

19. The one or more non-transitory computer-readable storage media of claim 16, wherein the customer system is an eProcurement system or a system that performs e-commerce activity.

20. The one or more non-transitory computer-readable storage media of claim 16, wherein the method further comprises:
receiving from the customer system an update that the buyer followed the address.
